(19) United States
(12) Patent Application Publication
(10) Pub. No.: US 2022/0371255 A1
(43) Pub. Date: Nov. 24, 2022

(54) CLOSING UNIT AND BLOW-MOULDING TOOL FOR A BLOW-MOULDING MACHINE

(71) Applicant: KAUTEX MASCHINENBAU GMBH, Augsburg (DE)

(72) Inventor: MICHAEL BLÖMER, Bonn (DE)

(21) Appl. No.: 17/764,885

(22) PCT Filed: Sep. 28, 2020
(86) PCT No.: PCT/EP2020/077060

§ 371 Date: May 25, 2022

(30) Foreign Application Priority Data
Sep. 30, 2019 (DE) 10 2019 126 397.2

(51) Int. Cl. B29C 49/56; B29C 49/54

(52) U.S. Cl. CPC B29C 49/5605; B29C 49/54; B29C 2049/4892

(57) ABSTRACT

An arrangement is described. The arrangement comprises a closing unit for a blow-molding machine having a first and second mold carrier and a blow-molding tool arranged on the closing unit having two tool halves. A mold lower part of each tool half is movable in relation to the mold upper part of each tool half in a second movement direction different from the first movement direction back and forth between an open state and a closed state by means of at least one first or at least one second actuator and the blow-molding tool in the closed state of the two tool halves delimits a mold cavity having undercuts when the two mold lower parts are also in the closed state. The actuators, for example hydraulic cylinders, may arranged on the closing unit and make them able to be coupled to the mold lower part.

### CROSS REFERENCE

The present Application for Patent claims priority to International Patent Application No. PCT/EP2020/077060 by Blömer, entitled “CLOSING UNIT AND BLOW-MOULDING TOOL FOR BLOW-MOULDING MACHINE”, filed Sep. 28, 2020, which claims priority to German Patent Application No. 102019126397.2 by Blömer, entitled “CLOSING UNIT AND BLOW-MOULDING TOOL FOR BLOW-MOULDING MACHINE”, filed Sep. 30, 2019, each of which is assigned to the assignee hereof, and each of which is expressly incorporated by reference in its entirety herein.

### BACKGROUND

In practice, the containers may be produced to have depressions on the lower side or upper side or both, for example, to form a curved container base or a handle region. The depressions may represent an undercut with respect to lateral demolding of the containers from the tool halves. For this reason, two-part tool halves of a blow-molding tool may be used, the lower bottom half of which can be lowered in relation to a mold upper part of the tool half.

### SUMMARY

The examples described herein relate to a closing unit for blow-molding machine having a first and second mold carrier and a blow-molding tool arranged on the closing unit and having two tool halves, wherein

each tool half is detachably fastened on one of the two mold carriers and has a mold upper part and a mold lower part,

the two tool halves are movable back and forth between an open state and a closed state in a first movement direction,

the mold lower part of each tool half is movable in relation to the mold upper part of each tool half in a second movement direction different from the first movement direction back and forth between an open state and a closed state by means of at least one first or at least one second actuator, respectively, and

the blow-molding tool delimits a mold cavity having undercuts in the closed state of the two tool halves, when the two mold lower parts are also in the closed state.

The examples described herein relate to the production of hollow bodies in the course of blow-molding, in particular the production of containers from plastic, for example, canisters or bottles. During the production of such hollow bodies in the course of blow-molding, for example, an extruder having a die head creates a tubular preform, which is enclosed by the blow-molding tool and is expanded by compressed air introduced by means of a blow pin in such a way that the relevant hollow body obtains the internal contour of the blow-molding tool. The two tool halves are generally movable toward one another in the horizontal direction by means of a closing unit to open or close the blow-molding tool. The structure of such a closing unit is disclosed, for example, in DE 10 2012 109 499 A1.

In practice, the containers to be produced can have depressions on the lower side or upper side or both, for example, to form a curved container base or a handle region. The depressions represent an undercut with respect to lateral demolding of the containers from the tool halves. For this reason, two-part tool halves of a blow-molding tool are known from the prior art, the lower bottom half of which can be lowered in relation to a mold upper part of the tool half. To demold a container, the lower bottom half of each tool half is lowered separately via at least one hydraulic cylinder and subsequently raised again for a new production cycle of a container.

In a first blow-molding tool used in practice, two hydraulic cylinders are each fastened laterally adjacent to the mold upper part on a framework of the tool half and connected on the output side via the piston rod to the bottom half. In a second blow-molding tool used in practice, only one hydraulic cylinder is fastened on the framework of the tool half below the lower bottom half and connected on the output side via the piston rod to the lower side of the bottom half.

The disadvantage of the first blow-molding tool is that two actuators are required per tool half and the structural width of the blow-molding tool resulting from their arrangement can cause problems. In the second blow-molding tool, a lateral change of the blow-molding tool is not possible.

U.S. Pat. No. 5,026,268 A discloses a blow-molding system for simultaneous blow-molding of plant containers, the edge regions of which are compression molded. Each tool half of the blow-molding tool has a total of five mold parts. The respective two lower and upper mold parts of each tool half are rigidly connected to one another and in turn rigidly fastened on a base of the respective mold half. This base is part of the blow-molding tool and forms the framework of each of the two tool halves. A hydraulic cylinder is fastened in each case on this framework of the blow-molding tool, which is connected via a piston rod to the two lower mold parts. The lower mold parts of each tool half, which are fixedly connected to one another, are movable relatively to a mold part located in between in the direction of a guide rod connecting the mold parts. The mold part located in between is movable relative to the two upper mold parts fixedly connected to the base of each mold half in the direction of a further guide rod. This relative movement permits the compression molding of the edge region of the two plant containers.

Proceeding from this prior art, the examples described herein are based on the object of refining an arrangement made up of closing unit and blow-molding tool in such a way that the mold clamping area of the blow-molding tool is not restricted by the actuators, at the same time the costs for blow-molding tools are reduced and the change of the blow-molding tool is simplified.

The achievement of the object is based on the concept of arranging the actuators, for example hydraulic cylinders, not as previously on the blow-molding tool itself, but rather on the closing unit and designing them so they can be coupled to the mold lower part.

In detail, the object is achieved in a closing unit of the type mentioned at the outset in that the at least one first actuator and the at least one second actuator are arranged on the closing unit and one of the two mold lower parts is detachably connected to an output of the at least one first actuator and the other of the two mold lower parts is detachably connected to an output of the at least one second actuator.

According to the examples described herein, the actuators become part of the closing unit of the blow-molding machine and remain on the closing unit upon the change. If multiple blow-molding tools are used in the blow-molding machine, only one set of actuators may be used. Due to the detachable connection between each actuator and one of the two mold lower parts, the change of the blow-molding tool is simplified. At the same time, the installation space of the blow-molding tools is reduced.

The actuators can be positioned on the machine side in a manner optimized with respect to installation space in a space that is not usable or usable to a restricted extent for the blow-molding tool. The actuators are preferably arranged below the mold lower parts and detachably connected to the lower side of the respective mold lower part.

If the at least one actuator is arranged below the mold lower part and is detachably connectable to the lower side of the mold lower part, the blow mold tool may be removed from the closing unit laterally, that is to say transversely to the closing direction of the two tool halves.

The at least one first actuator and the at least one second actuator are arranged movably against one another in the first movement direction on the closing unit.

To be able to actuate the actuators already during the movement of the tool halves in the first movement directions, in an example, it is provided that the at least one first actuator moves synchronously with the first mold carrier and the at least one second actuator moves synchronously with the second mold carrier.

To synchronize the movement, in an example, the at least one first actuator can be arranged directly on the first mold carrier and the at least one second actuator can be arranged directly on the second mold carrier. A fastening bracket for the indirect fastening of the at least one first actuator can be arranged on the first mold carrier and a fastening bracket for the indirect fastening of the at least one second actuator can be arranged on the second mold carrier.

To synchronize the movement, it is provided in an example that:

the at least one first actuator and the at least one second actuator are arranged movably on the closing unit along at least one fixed longitudinal guide,

a first coupler transfers the movement of the first mold carrier to the at least one first actuator and a second coupler transfers the movement of the second mold carrier to the at least one second actuator.

A coupling rod or a carrier element comes into consideration as a coupler, for example.

A fixed guide provided on the closing unit can be used as the fixed longitudinal guide for the actuators, along which the first and the second mold carrier are displaceably guided. Alternatively, a separate fixed longitudinal guide is provided for the actuators.

By means of the detachable connection between actuator and mold lower part, a defined interface is provided for the force transmission. To be able to detach and reestablish the connection between actuator and mold lower part quickly, the detachable connection is embodied in an examples a coupling, which is configured for transmitting forces between the actuator and the mold lower part at least in the second movement direction, that is to say perpendicularly to the horizontal closing and opening movement of the two tool halves.

In the interest of automation of the coupling procedure, the coupling is preferably embodied as a switchable, friction-locked, or formfitting coupling, for example, as an electromagnetic coupling.

The actuators are configured in such a way that they can move the mold lower part in the second movement direction linearly back and forth between the open state and the closed state. The actuators can be embodied as linear drives, in particular as fluid-operated working cylinders. Alternatively, the actuator is a slider crank mechanism, which converts a rotational movement into an oscillating thrust movement in the second movement direction.

The second movement direction of the mold lower parts is typically perpendicular to the first movement direction for opening and closing the blow-molding tool, but can also extend at a different angle in dependence on the hollow body to be produced.

### BRIEF DESCRIPTION OF THE DRAWINGS

The following is explained in more detail hereinafter on the basis of the figures. In the figures:

FIG. 1 shows a side view of a first example of a closing unit for a blow-molding machine,

FIG. 2 shows a longitudinal section through the closing unit according to FIG. 1,

FIG. 3 shows a perspective view of the closing unit according to FIG. 1,

FIG. 4 shows a side view of a second example of a closing unit for a blow-molding machine,

FIG. 5 shows a top view of the closing unit according to FIG. 4,

FIG. 6 shows a perspective view of the closing unit according to FIG. 4,

FIG. 7 shows a side view, partially broken away, of a second example of a closing unit for a blow-molding machine,

FIG. 8 shows a top view of the closing unit according to FIG. 7, and

FIG. 9 shows a perspective view of the closing unit according to FIG. 7.

### DETAILED DESCRIPTION

Reference is made in addition to DE 10 2012 109 499 A1 with respect to the structure of the closing unit (1), in particular the common drive for moving the mold carriers back and forth, the base frame having guides arranged thereon, the U-shaped frame elements, and the synchronizing unit.

FIGS. 1-3 show a first example of the closing unit 1 for a blow-molding machine having a blow-molding tool having two tool halves (2, 3), wherein each tool half (2, 3) has a mold upper part (2.1, 3.1) and a mold lower part (2.2, 3.2). The tool half (2) is detachably fastened on a first mold carrier (4) and the tool half (3) is detachably fastened on a second mold carrier (5). The first mold carrier (4) is connected in an articulated manner to the two frame elements (6) of the closing unit (1). The second mold carrier (5) is connected to a drive (7) for moving the two mold carriers (4, 5) and thus the tool halves (2, 3) back and forth, wherein the drive (7) is also supported on the frame elements (6).

The closing unit (1) has a base frame, which has side jaws (9) arranged at a parallel distance to one another, at the upper end of each of which a longitudinal guide (8) is arranged. The first and second mold carriers (4, 5) and the drive (7) are connected to guide elements, which are arranged displaceably on the longitudinal guides (8). Moreover, a synchronizing unit (10) is arranged on the base frame of the closing unit (1), due to which the closing and opening movement of the two tool halves (2, 3) in a first movement direction (17) takes place symmetrically.

FIGS. 1-3 show the two tool halves (2, 3) in an open state. The mold lower parts (2.2, 3.2) are also located in an open state. In the closed state, the two tool halves (2, 3) and the respective mold upper and lower parts (2.1, 2.2 or 3.1, 3.2) abut one another and delimit a mold cavity for producing a hollow body, in particular a canister.

A fastening bracket (11, 12) is fastened on the lower side in each case on the first mold carrier (4) and on the second mold carrier (5). A first actuator (13) or a second actuator (14), respectively, is fastened on each fastening bracket (11, 12) below the mold lower part (2.2, 3.2). The first actuator (13) and the second actuator (14) are each detachably connectable to the lower side of the assigned mold lower part (2.2, 3.2) via a switchable coupling (15, 16).

By means of the actuator (13, 14), which is embodied as a linear drive, for example, the mold lower parts (2.2, 3.2) may be moved in relation to the mold upper parts (2.1, 3.1) of the two tool halves (2, 3) in a second movement direction (18) in the perpendicular direction to move the mold lower part (2.2, 3.2) of each tool half (2, 3) in relation to the mold upper part (2.1) of the respective tool half (2, 3) back and forth between an open state and a closed state. The second movement direction (18) extends perpendicularly to the first movement direction (17).

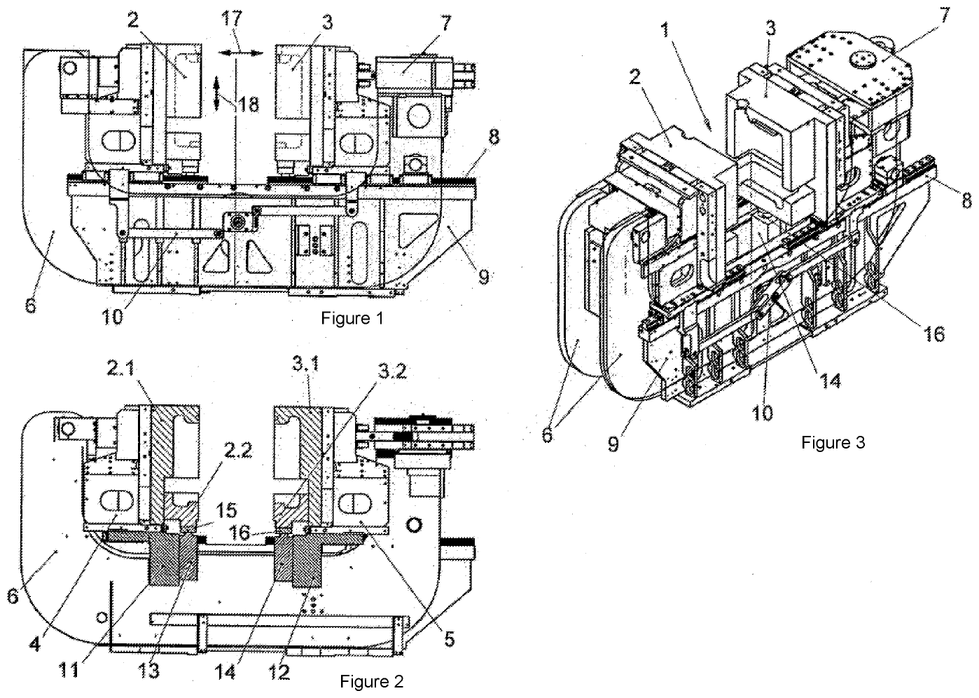

It may be seen from FIG. 2 that both the two mold upper parts (2.1, 3.1) and the two mold lower parts (2.2, 3.2) have mold regions which are designed to form depressions on the lower and upper side of the hollow body to be produced. These mold regions require the mold lower parts (2.2, 3.2) to be moved into an open state by means of the actuators (13, 14) before the demolding of the hollow body.

Due to the arrangement of the actuators (13, 14) in the intermediate space between the frame elements (6), the form clamping area is not negatively affected. Furthermore, the couplings (15, 16) engaging on the lower side of the mold lower parts (2.2, 3.2) facilitate the change of the blow-molding tool. Finally, the figures show that the production free space for the hollow bodies is not restricted by the actuators (13, 14).

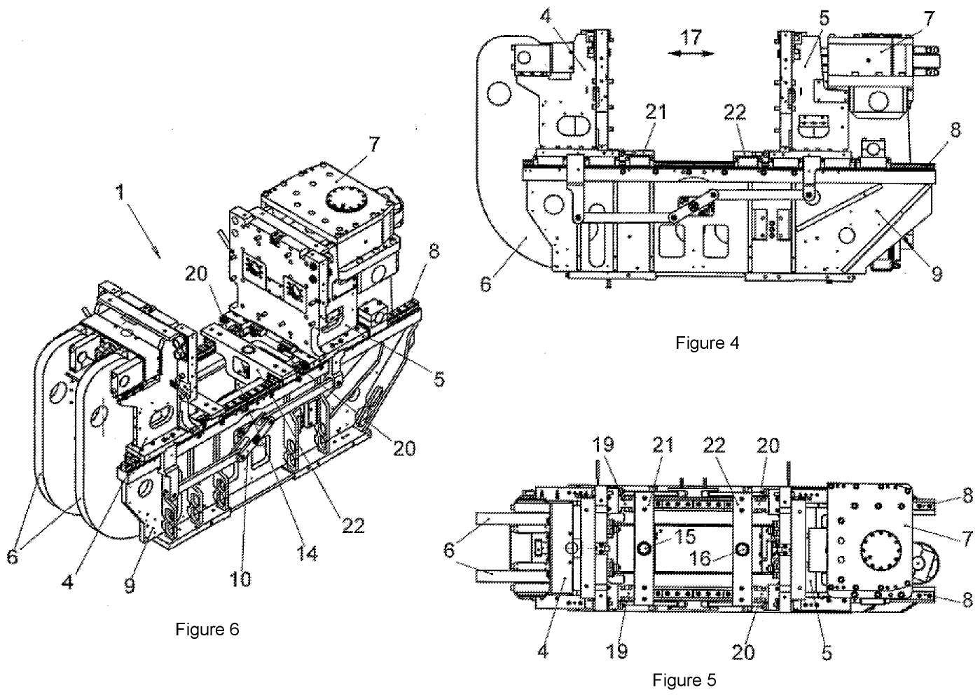

FIGS. 4-6 show a second example of the closing unit (1) for a blow-molding machine having a blow-molding tool which substantially corresponds in the structure to the closing unit (1) according to FIGS. 1-3. Corresponding components and assemblies of the second example are provided with identical reference signs. Differences from the first example exist insofar as to how the first actuator (13) moves synchronously with the first mold carrier (4) and the second actuator (14) moves synchronously with the second mold carrier (5). In the illustrations according to FIGS. 4-6, the tool halves (2, 3) were not shown in order to be able to better illustrate the components required for the synchronous movement.

The closing unit (1) has a base frame as in the first example, which has side jaws (9) arranged at a distance in parallel to one another, on the upper edge of each of which a longitudinal guide (8) is arranged. The first and second mold carrier (4, 5) and the drive (7) are connected to guide elements, which are arranged displaceably on the longitudinal guides (8).

To synchronize the movement, it is provided that the first actuator (13) and the second actuator (14) are also arranged movably on the closing unit (1) along the fixed longitudinal guides (8) provided in any case and a first coupler (19) transmits the movement of the first mold carrier (4) to the first actuator (13) and a second coupler (20) transmits the movement of the second mold carrier (5) to the second actuator (14).

To move the first and second actuator (13, 14) along the longitudinal guides (8), a first and a second bracket (21, 22) are provided. Each of the two brackets (21, 22) is provided at the outer edges with guide elements, which are arranged displaceably on the longitudinal guides (8), which are arranged at a distance in parallel. The first actuator (13) is fastened in the center on the first bracket (21) and the second actuator (14) is fastened in the center on the second bracket. The first coupler (19) comprises two profile parts, which are fastened on one side on the first mold carrier (4) and on the other side on the outer edges of the first bracket (21). The second coupler (20) also comprises two profile parts, which are fastened on one side on the second mold carrier (5) and on the other side on the outer edges of the second bracket (22).

If the mold carriers (4, 5) move in the first movement direction (17), the first and second bracket (21, 22) are also moved synchronously, so that the actuators (13, 14) fastened on the brackets (21, 22) are located below the mold lower parts (2.2, 3.2).

Via the switchable coupling (15, 16), the first actuator (13) and the second actuator (14) are respectively detachably connectable to the lower side of the assigned mold lower part (2.2, 3.2).

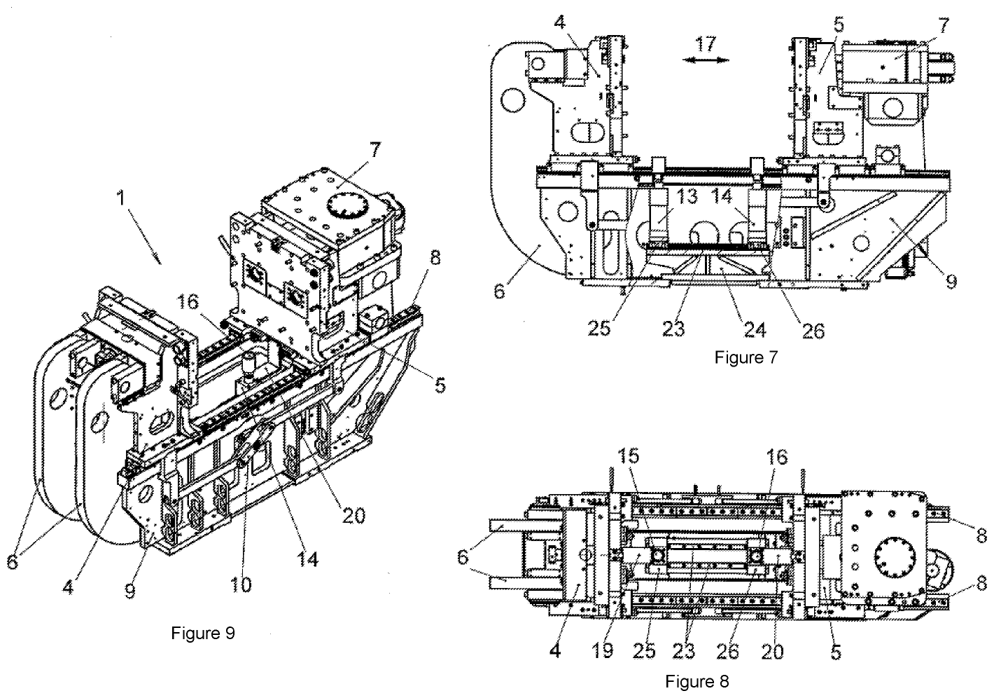

FIGS. 7-9 show a third example of the closing unit (1) for a blow-molding machine having a blow-molding tool, which substantially corresponds in the structure to the closing unit according to FIGS. 1-3. Corresponding components and assemblies of the third example are provided with the same reference signs. Differences from the first example exist insofar as to how the first actuator (13) moves synchronously with the first mold carrier (4) and the second actuator (14) moves synchronously with the second mold carrier (5). In the illustrations according to FIGS. 7-9, the tool halves (2, 3) were not shown to be able to better illustrate the components used for the synchronous movement.

As in the first example, the closing unit (1) has a base frame, which has side jaws (9) arranged at a distance to one another in parallel, on the upper edge of each of which a longitudinal guide (8) is arranged. The first and second mold carriers (4, 5) and the drive (7) are connected to guide elements, which are arranged displaceably on the longitudinal guides (8).

To synchronize the movement, it is provided that the first actuator (13) and the second actuator (14) are arranged movably on the closing unit (1) along additional fixed longitudinal guides (23). The fixed longitudinal guides (23) are arranged at a distance to one another in parallel in the intermediate space between the side jaws (9) and the frame elements (6) on a support structure (24), which is fastened at the bottom on the base frame of the closing unit (1).

The first coupler (19) transmits the movement of the first mold carrier (4) to the first actuator (13) and the second coupler (20) transmits the movement of the second mold carrier (5) to the second actuator (14).

To move the first and second actuator (13, 14) along the additional longitudinal guides (23), a first and a second guide carriage (25, 26) are provided, which are displaceably guided on the additional longitudinal guides (23), which are arranged at a distance in parallel. The first actuator (13) extends upward in the vertical direction from the first guide carriage (25) and the second actuator (14) extends upward in the vertical direction from the second guide carriage (26). The first coupler (19) comprises an angled profile, which is fastened on one side on the first mold carrier (4) and on the other side on the first actuator (13). The second coupler (20) comprises an angled profile, which is fastened on one side on the second mold carrier (5) and on the other side on the second actuator (14).

If the mold carriers (4, 5) move in the first movement direction (17), the actuators (13, 14) arranged on the guide carriages (25, 26) are also moved synchronously.

The first actuator (13) and the second actuator (14) are each detachably connectable to the lower side of the assigned mold lower part (2.2, 3.2) via the switchable coupling (15, 16).

### LIST OF REFERENCE NUMERALS

1 closing unit
2 tool half
2.1 mold upper part
2.2 mold lower part
3 tool half
3.1 mold upper part
3.2 mold lower part
4 first mold carrier
5 second mold.
6 frame elements
7 drive
8 longitudinal guide
side jaws
10 synchronizing unit
11 fastening bracket
12 fastening bracket
13 first actuator
14 second actuator
15 coupling
16 coupling
17 first movement direction
18 second movement direction
19 first coupler
20 second coupler
21 first bracket
22 second bracket
23 additional longitudinal guide
24 support structure
25 first guide carriage
26 second guide carriage

1. A closing unit for a blow-molding machine comprising:
a first mold carrier;
a second mold carrier; and
a blow-molding tool arranged on the closing unit having two tool halves, wherein
each tool half is detachably fastened on one of the two mold carriers and has a mold upper part and a mold lower part,
the two tool halves are movable back and forth between an open state and a closed state in a first movement direction,
the mold lower part of each tool half is movable with respect to the mold upper part of each tool half in a second movement direction different from the first movement direction back and forth between an open state and a closed state by at least one first actuator or at least one second actuator, respectively, and
the blow-molding tool, in the closed state of the two tool halves, forms a mold cavity having undercuts when the two mold lower parts are also in the closed state,
wherein the at least one first actuator and the at least one second actuator are arranged on the closing unit and one of the two mold lower parts is detachably connected to an output of the at least one first actuator and the other of the two mold lower parts is detachably connected to an output of the at least one second actuator.

2. The closing unit of claim 1,
wherein the at least one first actuator and the at least one second actuator are arranged movably in the first movement direction on the closing unit.

3. The closing unit of claim 2, wherein:
the at least one first actuator moves synchronously with the first mold carrier and
the at least one second actuator moves synchronously with the second mold carrier.

4. The closing unit of claim 3, wherein the at least one first actuator is arranged on the first mold carrier and the at least one second actuator is arranged on the second mold carrier.

5. The closing unit of claim 4, wherein a fastening bracket for fastening the at least one first actuator is arranged on the first mold carrier and a fastening bracket for fastening the at least one second actuator is arranged on the second mold carrier.

6. The closing unit of claim 3, wherein:
the at least one first actuator and the at least one second actuator are arranged movably on the closing unit along at least one fixed longitudinal guide,
a first coupler transmits the movement of the first mold carrier to the at least one first actuator and a second coupler transmits the movement of the second mold carrier to the at least one second actuator.

7. The closing unit of claim 1, wherein the at least one first and the at least one second actuator are arranged below the mold lower parts and are detachably connected to the lower side of the respective mold lower part.

8. The closing unit of claim 1, wherein the closing unit has a fixed guide, along which the first and the second mold carrier are displaceably guided.

9. The closing unit of claim 8, wherein the at least one first actuator and the at least one second actuator are arranged movably on the closing unit along the fixed longitudinal guide for the two mold carriers.

10. The closing unit of claim 1, wherein a detachable connection between the at least one first actuator and one of the two mold lower parts and the at least one second actuator and the other of the two mold lower parts is a coupling in each case, which is configured to transmit forces between a respective actuator and a respective mold lower part at least in the second movement direction.

11. The closing unit of claim 10, wherein the coupling is a switchable, friction-locked, or formfitting coupling.

12. The closing unit of claim 1, wherein each actuator is a linear drive or a slider crank mechanism.

13. The closing unit of claim 1, wherein the first movement direction is perpendicular to the second movement direction.
